(19) United States
(12) Patent Application Publication
(10) Pub. No.: US 2026/0146136 A1
(43) Pub. Date: May 28, 2026

(54) COATED PELLET AND METHOD FOR MANUFACTURING THE SAME

(71) Applicants: SK INNOVATION CO., LTD., Seoul (KR); SK GEO CENTRIC CO., LTD., Seoul (KR)

(72) Inventors: Won Bin KIM, Daejeon (KR); Hong Chan KIM, Daejeon (KR); Ji Hye PARK, Daejeon (KR); In Su LEE, Daejeon (KR); Ho Seong LEE, Daejeon (KR); Jun Hee HAN, Daejeon (KR)

(21) Appl. No.: 19/396,333

(22) Filed: Nov. 21, 2025

(30) Foreign Application Priority Data
Nov. 25, 2024 (KR) 10-2024-0169873

(51) Int. Cl. C08J 3/12; C08F 210/02

(52) U.S. Cl. CPC C08J 3/128; C08F 210/02; C08F 2800/20; C08J 2323/08

(57) ABSTRACT

A coated pellet according to embodiments of the present disclosure includes a core including a (meth)acrylic resin, and an anti-blocking coating formed on a surface of the core and including an alkali metal salt. The content of the alkali metal salt is 3 ppm to 7,000 ppm based on the total weight of the core and the anti-blocking coating. In a method for manufacturing coated pellets according to embodiments of the present disclosure, a coating solution including an alkali metal salt and a solvent is prepared. A core including a (meth)acrylic resin and the coating solution are mixed to produce a preliminary coated pellet. The preliminary coated pellet is dried to produce a coated pellet. The content of the alkali metal salt is 0.03% by weight to 5% by weight based on the total weight of the coating solution.

### CROSS-REFERENCE TO RELATED APPLICATION

The present application claims priority to Korean patent application number 10-2024-0169873 filed on Nov. 25, 2024 which is incorporated herein by reference in its entirety.

### BACKGROUND

### 1. Technical Field

Embodiments of the present disclosure relate to a coated pellet and a method for manufacturing the same.

### 2. Description of the Related Art

Acrylic resins, which are high-molecular-weight polymers, are transparent resins with excellent transparency, weather resistance, and mechanical properties. Due to these properties, acrylic resins are used in a variety of fields requiring transparency.

Acrylic resins are typically produced, stored, and distributed in the form of pellets. However, the ester or carboxyl groups contained in the acrylic resins are highly polar functional groups that can react and bond with each other on the surfaces of the pellets, potentially forming aggregates. This may reduce the processability of acrylic resin pellets, and their marketability may be significantly reduced during long-term storage, making them difficult to use.

Techniques have been proposed to prevent caking or blocking, which are aggregation phenomena of pellets. For example, techniques have been proposed to mix anti-blocking agents during the formation of pellets or to apply anti-blocking treatments to the pellet surfaces. However, these techniques may fail to prevent caking during long-term storage of acrylic resin pellets, or discoloration of the pellets may lead to reduced marketability.

### SUMMARY

An embodiment of the present disclosure provides a coated pellet in which agglomeration is suppressed.

Another embodiment of the present disclosure provides a method for manufacturing the coated pellet.

The coated pellets may be acrylic pellets coated with a coating material.

A coated pellet according to the present disclosure includes a core including a (meth)acrylic resin; and an anti-blocking coating formed on a surface of the core and including an alkali metal salt. The content of the alkali metal salt is about 3 ppm to about 7,000 ppm based on the total weight of the core and the anti-blocking coating.

In various embodiments, the content of the alkali metal salt may be about 10 ppm to about 3,000 ppm based on the total weight of the core and the anti-blocking coating.

In some embodiments, the (meth)acrylic resin may include a (meth)acrylic acid-derived repeating unit.

In some embodiments, the content of the (meth)acrylic acid-derived repeating unit may be about 10% by weight to about 30% by weight based on the total weight of the (meth)acrylic resin.

In some embodiments, the content of the (meth)acrylic acid-derived repeating unit may be about 10% by weight to about 20% by weight based on the total weight of the (meth)acrylic resin. In some embodiments, the alkali metal salt may include a sodium salt.

In some embodiments, the alkali metal salt may include an alkali metal phosphate.

In some embodiments, the alkali metal salt may not include an alkali metal carboxylate.

In some embodiments, the alkali metal salt may include at least one selected from the group consisting of trisodium phosphate, sodium sulfite, sodium silicate, and sodium caprylate.

In some embodiments, the (meth)acrylic resin may include a repeating unit derived from a (meth)acrylic monomer, and the (meth)acrylic monomer may include at least one selected from the group consisting of an alkyl (meth)acrylate, a hydroxyl-containing (meth)acrylate, a carboxyl-containing (meth)acrylate, and an alkoxy-containing (meth)acrylate.

In some embodiments, the pH of the alkali metal salt may be greater than the pH of the (meth)acrylic resin.

According to a method for manufacturing a coated pellet of the present disclosure, a coating solution including an alkali metal salt and a solvent is prepared. A core including a (meth)acrylic resin is mixed with the coating solution to produce a preliminary coated pellet. The preliminary coated pellet is dried to produce a coated pellet. The content of the alkali metal salt is about 0.03% by weight to about 5% by weight based on the total weight of the coating solution.

In some embodiments, the content of the alkali metal salt may be about 0.03% by weight to about 0.5% by weight based on the total weight of the coating solution.

In some embodiments, the drying may be performed for about 20 to about 30 hours.

In some embodiments, the drying may be performed at a temperature of about 20° C. to about 30° C.

The coated pellet according to embodiments of the present disclosure may be capable of preventing adhesion between pellets even when stored under high-pressure conditions. Accordingly, caking of the pellets may be prevented, and the handling and storability of the pellets may be improved.

According to the method for manufacturing a coated pellet of the present disclosure, adhesion between pellets may be reduced in a simple way.

### DETAILED DESCRIPTION

According to embodiments of the present disclosure, a coated pellet including a core having a coated surface is provided. In addition, a method for manufacturing the coated pellet is provided.

Hereinafter, embodiments of the present disclosure will be described in detail. However, these are merely illustrative and the embodiments of the present disclosure are not limited to the specific embodiments described.

The coated pellet according to some embodiments includes a core and an anti-blocking coating.

The core includes a (meth)acrylic resin, and the anti-blocking coating is formed on the surface of the core and includes an alkali metal salt.

The core may be prepared in the form of pellets composed of a (meth)acrylic resin and having no anti-blocking coating applied thereto. The core may be produced by methods known to those skilled in the art, or may be prepared by purchasing a commercially available product.

The (meth)acrylic resin may include a polymer or copolymer formed by polymerizing a (meth)acrylic monomer or a monomer mixture including a (meth)acrylic monomer. The (meth)acrylic resin may include repeating units derived from the (meth)acrylic monomer.

The term “(meth)acrylic monomer” may include a compound having an acrylic group (CH₂═CH—C(═O)—O—) or a methacrylic group (CH₂—C(CH₃)—C(═O)—O—) as a (meth)acrylic acid or (meth)acrylate monomer. The (meth)acrylic resin may be formed by polymerizing through cleavage of the carbon-carbon double bond in the (meth)acrylic group included in the (meth)acrylic monomer.

The (meth)acrylic monomer is not particularly limited as long as it has a (meth)acrylic group, but may include, for example, alkyl (meth)acrylates, hydroxyl group-containing (meth)acrylates, carboxyl group-containing (meth)acrylates, alkoxy group-containing (meth)acrylates, and the like. These may be used alone or in combination of two or more thereof.

The alkyl (meth)acrylate may include, for example, acrylic acid, methacrylic acid, and the like.

The alkyl (meth)acrylate may include, for example, methyl (meth)acrylate, ethyl (meth)acrylate, propyl (meth)acrylate, isopropyl (meth)acrylate, n-butyl (meth)acrylate, sec-butyl (meth)acrylate, 1,3-dimethylbutyl (meth)acrylate, pentyl (meth)acrylate, isopentyl (meth)acrylate, hexyl (meth)acrylate, 2-ethylbutyl (meth)acrylate, heptyl (meth)acrylate, n-octyl (meth)acrylate, isooctyl (meth)acrylate, 2-ethylhexyl (meth)acrylate, n-nonyl (meth)acrylate, isononyl (meth)acrylate, n-decyl (meth)acrylate, isodecyl (meth)acrylate, n-dodecyl (meth)acrylate, n-tridecyl (meth)acrylate, n-tetradecyl (meth)acrylate, and the like. These may be used alone or in combination of two or more thereof.

The hydroxyl group-containing (meth)acrylate may include, for example, 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, (4-hydroxymethylcyclohexyl)methyl (meth)acrylate, and the like. These may be used alone or in combination of two or more thereof.

The carboxyl-containing (meth)acrylate may include, for example, carboxyethyl (meth)acrylate, carboxypentyl (meth)acrylate, and the like. These may be used alone or in combination of two or more thereof.

The alkoxy-containing (meth)acrylate may include, for example, 2-methoxyethyl acrylate, polyether-containing acrylate, and the like.

In addition to the (meth)acrylates listed above, the monomer mixture may further include polymerizable monomers having unsaturated groups.

For example, the polymerizable monomer may include aromatic alkenyl monomers such as styrene, α-methylstyrene, p-methylstyrene, and p-methoxystyrene; vinyl cyanide monomers such as acrylonitrile, and methacrylonitrile; and unsaturated aliphatic monomers such as butadiene, ethylene, and propylene.

In some embodiments, the (meth)acrylic resin may include repeating units derived from (meth)acrylic acid monomers. For example, the (meth)acrylic resin may include a polymer of a monomer mixture including (meth)acrylic acid and ethylene.

In some embodiments, the content of the (meth)acrylic acid-derived repeating units may be about 10% by weight (“wt %”) to about 30 wt % based on the total weight of the (meth)acrylic resin. In some embodiments, the content of the (meth)acrylic acid-derived repeating units may be about 13 wt % to about 27 wt %, about 13.5 wt % to about 25 wt %, or about 18 wt % to about 23 wt % based on the total weight of the (meth)acrylic resin.

Within the above range, the caking and blocking prevention properties of the anti-blocking coating described below may be more effectively exhibited.

In some embodiments, the (meth)acrylic resin may include an ethylene-acrylic acid resin. The (meth)acrylic resin may include an ethylene-derived repeating unit and an acrylic acid-derived repeating unit. The content of the acrylic acid-derived repeating unit, based on the total weight of the ethylene-acrylic acid resin, may be about 10 wt % to about 30 wt %, and the content of the ethylene-derived repeating unit may be about 70 wt % to about 90 wt %.

According to some embodiments, the anti-blocking coating includes an alkali metal salt. The alkali metal salt may function as an anti-tacking agent.

The alkali metal salt may include an alkali metal having a higher ionization tendency, thereby enhancing the polarity of the anti-blocking coating and enabling the (meth)acrylic resin to bond firmly with the anti-blocking coating.

In addition, the alkali metal salt may be easily ionized, and the anti-blocking coating may include a large amount of cations. This can result in a repulsive force acting between the anti-blocking coatings and the surfaces of the coated pellets, thereby preventing caking of the pellets.

According to some embodiments, the alkali metal salt may include an alkali metal such as sodium, potassium, or rubidium.

According to some embodiments, the alkali metal salt may include a sodium salt. Sodium has a high ionization tendency, allowing it to form monovalent cations. Protons may rapidly migrate from the pellet surface, forming strong metal ion bonds on the pellet surface. This may increase the repulsive force between metal cations on the pellets, thereby preventing caking of the pellets.

In addition, sodium salts may have higher solubility in an aqueous solvent than calcium salts, thereby improving the efficiency of the manufacturing process for coated pellets.

The alkali metal salt may include inorganic anions such as silicate, sulfite, sulfate, phosphate, polyphosphate or hydrosulfite, or organic anions such as caprylate or citrate. In one embodiment, the alkali metal salt may include an inorganic anion.

According to some embodiments, the pH of the alkali metal salt may be 5 or more. In some embodiments, the pH of the alkali metal salt may be 6 or more, 7 or more, 8 or more, 9 or more, 10 or more, or 11 or more. Within this range, the pH of the alkali metal salt may be greater than the pH of the (meth)acrylic resin.

According to some embodiments, the alkali metal salt may include an alkali metal phosphate.

As a trivalent anion, phosphate may bind to a greater number of cations, thereby further enhancing the anti-blocking performance of the anti-blocking coating.

According to some embodiments, the alkali metal salt may include at least one selected from the group consisting of trisodium phosphate, sodium sulfite, sodium silicate, and sodium caprylate. In one embodiment, the alkali metal salt may include trisodium phosphate.

In some embodiments, the alkali metal salt may not include an alkali metal carboxylate. A carboxylate may react with the carboxyl or ester groups included in the (meth)acrylic resin, thereby promoting the occurrence of caking. Thus, an embodiment using an alkali metal salt that is free or substantially free of an alkali metal carboxylate, is preferred.

In some embodiments, the content of the alkali metal salt may be about 3 ppm to about 7,000 ppm based on the total weight of the core and the anti-blocking coating. In some embodiments, the content of the alkali metal salt may be about 3 ppm to about 6,000 ppm, about 3 ppm to about 3,000 ppm, or about 10 ppm to about 3,000 ppm based on the total weight of the core and the anti-blocking coating.

If the content of the alkali metal salt is less than about 3 ppm, adhesion between pellets cannot be prevented. If the content of the alkali metal salt is greater than about 7,000 ppm, the alkali metal salt may precipitate during the production process of the coated pellet, causing an uneven coating layer to form on the pellet surface, and potentially clogging the piping of the manufacturing equipment with the precipitate.

According to some embodiments, when the content of the (meth)acrylic acid-derived repeating unit is about 10 wt % to about 20 wt % based on the total weight of the (meth)acrylic resin of the core, the content of the alkali metal salt may be about 3 to about 2,000 ppm, or about 10 to about 1,500 ppm based on the total weight of the core and the anti-blocking coating.

According to some embodiments, when the content of the (meth)acrylic acid-derived repeating unit is greater than about 20 wt % and less than or equal to about 30 wt % based on the total weight of the (meth)acrylic resin of the core, the content of the alkali metal salt may be about 3 ppm to about 6,500 ppm or about 4.5 ppm to about 6,000 ppm based on the total weight of the core and the anti-blocking coating According to some embodiments, the average particle diameter of the coated pellets is not particularly limited, and the coating may be applied to prevent caking between resin pellets of various sizes.

According to an embodiment of the present disclosure, a method for manufacturing the coated pellets is provided.

According to some embodiments, a coating solution including the alkali metal salt and a solvent is prepared. The alkali metal salt may be any of the above-described salts, and the solvent is not particularly limited, but may be an aqueous sol vent capable of dissolving the alkali metal salt. For example, the solvent may be water.

According to some embodiments, the content of the alkali metal salt may be about 0.03 wt % to about 5 wt % based on the total weight of the coating solution. According to some embodiments, the content of the alkali metal salt may be about 0.03 wt % to about 0.5 wt % based on the total weight of the coating solution.

Within the above range, surface adhesion between pellets may be prevented while maintaining the pellet color and physical properties.

If the content of the alkali metal salt is less than about 0.03 wt %, adhesion of the pellets cannot be prevented. If the content of the alkali metal salt is greater than about 5 wt %, precipitates of the alkali metal salt may clog the piping of the manufacturing equipment during the manufacturing process of the coated pellets, thereby reducing productivity.

According to some embodiments, a core including the (meth)acrylic resin is mixed with the coating solution to produce preliminary coated pellets. The above-described (meth)acrylic resin may be used.

After adding the core to the coating solution, the mixture may be stirred and mixed for about 10 to 60 minutes. After mixing, the mixture may be filtered to obtain the preliminary coated pellets.

According to some embodiments, the preliminary coated pellets are dried to produce coated pellets. In the preliminary coated pellets, the solvent may remain on the core surface. Drying may be performed to remove the residual solvent and form an anti-blocking coating on the core surface.

According to some embodiments, the drying may be performed for 20 to 30 hours. For example, the drying may be conducted at a temperature of about 20° C. to about 30° C.

The coated pellets may remain free from adhesion to each other even when stored at high temperatures for an extended period. In some embodiments, a plurality of coated pellets may remain non-adherent even when stored at a temperature of about 40° C. to about 70° C. for about 10 hours or more. In one embodiment, the plurality of coated pellets may remain non-adherent even when stored at a temperature of about 45° C. to about 60° C. for about 15 hours or more.

The coated pellets may remain non-adherent even under high-temperature and high-pressure conditions. In some embodiments, a plurality of coated pellets may remain non-adherent even when stored at a temperature of about 40° C. to about 70° C. for about 10 hours or more under a pressure of about 0.4 bar g or higher. In some embodiments, the plurality of coated pellets may remain non-adherent even when stored at a temperature of about 45° C. to about 60° C. for about 15 hours or more under a pressure of about 0.5 bar g or higher.

Hereinafter, embodiments of the present disclosure will be further described with reference to specific experimental examples. However, the examples and comparative examples included in the experimental examples are provided merely for illustrative purposes of the embodiments of the present disclosure and are not intended to limit the scope of the appended claims. It will be apparent to those skilled in the art that various changes and modifications can be made within the scope and context of the present disclosure, and such changes and modifications are to be regarded as falling within the scope of the appended claims. Furthermore, the embodiments may be combined to form additional embodiments.

### Preparative Example 1

A monomer mixture including ethylene and acrylic acid in a weight ratio of 79.3:20.7 and an initiator were introduced into a reactor and reacted at a pressure of about 26,700 psig and a temperature of 245 to 260° C. for less than 1 minute. After the reaction, the unreacted monomers were removed through a depressurization process to obtain an ethylene-acrylic acid resin core.

### Preparative Example 2

A monomer mixture including ethylene and acrylic acid in a weight ratio of 86.5:13.5 and an initiator were introduced into a reactor and reacted at a pressure of about 31,000 psig and a temperature of 235 to 240° C. for less than 1 minute. After the reaction, the unreacted monomers were removed through a depressurization process to obtain an ethylene-acrylic acid resin core.

### Example 1

An aqueous solution containing 0.03 wt % trisodium phosphate as an alkali metal salt was prepared. 5 parts by weight of the acrylic resin core obtained in Preparative Example 1 were added to 100 parts by weight of the prepared aqueous solution and stirred for 30 minutes. The resulting preliminary coated pellets were filtered and then dried at room temperature (25° C.) for 24 hours to produce coated pellets.

### Examples 2 to 28 and Comparative Examples 1 to 6

Coated pellets were prepared in the same manner as in Example 1, except that the type and content of the alkali metal salt in the aqueous solution, and the type of acrylic resin core, were varied as shown in Table 1 below.

The content of the alkali metal salt in the coated pellets of the examples and comparative examples was measured using an inductively coupled plasma (ICP) analyzer.

Specifically, about 0.55 g of the coated pellets from the examples and comparative examples were mixed with sulfuric acid and heated to cause carbonization. The mixture was then cooled to room temperature and subjected to two-step ashing in an electric furnace at 250° C. and 600° C. After completion of the ashing process, the mixture was cooled again to room temperature, nitric acid was added, and the mixture was heated to dissolve the residue, thereby preparing a solution. The resulting diluted solution was analyzed using the ICP analyzer to determine the content of the alkali metal salt.

TABLE 1

| | Alkali metal salt | | | Acrylic |
|---|---|---|---|---|
| | | Content of | Content of coated | resin |
| | Type | solution (wt %) | pellets (ppm) | core |
| Example 1 | TSP | 0.03 | 4.7 | A-1 |
| Example 2 | TSP | 0.05 | 5.1 | A-1 |
| Example 3 | TSP | 0.1 | 8.7 | A-1 |
| Example 4 | TSP | 0.3 | 1,400 | A-1 |
| Example 5 | TSP | 0.5 | 1,300 | A-1 |
| Example 6 | TSP | 1 | 3,400 | A-1 |
| Example 7 | TSP | 5 | 6,000 | A-1 |
| Comparative | TSP | 0 | 0 | A-1 |
| Example 1 | | | | |
| Comparative | TSP | 0.01 | 0 | A-1 |
| Example 2 | | | | |
| Example 8 | TSP | 0.03 | 11 | A-2 |
| Example 9 | TSP | 0.05 | 12 | A-2 |
| Example 10 | TSP | 0.1 | 25 | A-2 |
| Example 11 | TSP | 0.3 | 119 | A-2 |
| Example 12 | TSP | 0.5 | 258 | A-2 |
| Comparative | TSP | 0 | 0 | A-2 |
| Example 3 | | | | |
| Example 13 | SS | 0.03 | 3.1 | A-1 |
| Example 14 | SS | 0.05 | 7.7 | A-1 |
| Example 15 | SS | 0.1 | 10.5 | A-1 |
| Example 16 | SS | 0.3 | 1,900 | A-1 |
| Example 17 | SS | 0.5 | 2,200 | A-1 |
| Example 18 | SS | 5 | 2,200 | A-1 |
| Comparative | SS | 0.01 | 0 | A-1 |
| Example 4 | | | | |
| Example 19 | SS | 0.03 | 5.8 | A-2 |
| Example 20 | SS | 0.05 | 5.8 | A-2 |
| Example 21 | SS | 0.1 | 25 | A-2 |
| Example 22 | SS | 0.3 | 78 | A-2 |
| Example 23 | SS | 0.5 | 264 | A-2 |
| Example 24 | SS | 1 | 341 | A-2 |
| Example 25 | SS | 3 | 1,100 | A-2 |
| Example 26 | SS | 5 | 1,500 | A-2 |
| Comparative | SS | 0 | 0 | A-2 |
| Example 5 | | | | |
| Example 27 | SP | 0.3 | 85 | A-2 |
| Example 28 | SP | 0.5 | 208 | A-2 |
| Comparative | SP | 0 | 0 | A-2 |
| Example 6 | | | | |

The abbreviations in Table 1 above have the following meanings:
TSP: Trisodium phosphate
SS: Sodium silicate
SP: Sodium caprylate
A-1: Ethylene-acrylic acid resin core of Preparative Example 1 (acrylic acid content: 20.7 wt %)
A-2: Ethylene-acrylic acid resin core of Preparative Example 2 (acrylic acid content: 13.5 wt %)

### Experimental Example

About 5.0 g of the coated pellets of the examples and comparative examples were placed in a stainless steel cup, and a pressure was applied thereto using a 4.5 kg (about 0.55 bar g) weight. The cup was then placed in an oven at 50° C. and maintained for 17 hours. After removal from the oven, the cup was inverted, and the weight of the pellets that fell from the cup was measured and calculated as a percentage relative to the initial loading of 5.0 g. For example, when all of the pellets fell from the cup, the evaluation value was 100%, and when al of the pellets agglomerated and did not fall from the cup, the evaluation value was 0%. The evaluation results are shown in Table 2 below.

TABLE 2

| | Evaluation value (%) |
|---|---|
| Example 1 | 5.71 |
| Example 2 | 8.2 |
| Example 3 | 10.89 |
| Example 4 | 96.46 |
| Example 5 | 100 |
| Example 6 | 100 |
| Example 7 | 100 |
| Comparative Example 1 | 0 |
| Comparative Example 2 | 0 |
| Example 8 | 100 |
| Example 9 | 100 |
| Example 10 | 100 |
| Example 11 | 100 |
| Example 12 | 100 |
| Comparative Example 3 | 35 |
| Example 13 | 6 |
| Example 14 | 100 |
| Example 15 | 100 |
| Example 16 | 100 |
| Example 17 | 100 |
| Example 18 | 100 |
| Comparative Example 4 | 0 |
| Example 19 | 100 |
| Example 20 | 100 |
| Example 21 | 100 |
| Example 22 | 100 |
| Example 23 | 100 |
| Example 24 | 100 |
| Example 25 | 100 |
| Example 26 | 100 |
| Comparative Example 5 | 42.83 |
| Example 27 | 64.57 |
| Example 28 | 83.52 |
| Comparative Example 6 | 35 |

Referring to Table 2 above, it was confirmed that the coated pellets of Examples 1 to 7, which used trisodium phosphate as the alkali metal salt and the ethylene-acrylic acid resin core of Preparative Example 1, exhibited higher evaluation values and showed reduced agglomeration as compared to the coated pellets of Comparative Examples 1 and 2. In addition, in Examples 8 to 12, which used the ethylene-acrylic acid resin core of Preparative Example 2, it was confirmed that agglomeration occurred less frequently than in the coated pellets of Comparative Example 3.

The coated pellets of Examples 13 to 18, which used sodium silicate as the alkali metal salt and the ethylene-acrylic acid resin core of Preparative Example 1, exhibited higher evaluation values than the coated pellets of Comparative Example 4, confirming that agglomeration occurred less frequently. In addition, Examples 19 to 26, which used the ethylene-acrylic acid resin core of Preparative Example 2, exhibited higher evaluation values than Comparative Example 5.

Examples 27 and 28, which used sodium caprylate as the alkali metal salt and the ethylene-acrylic acid resin core of Preparative Example 2, exhibited higher evaluation values than Comparative Example 6, confirming reduced agglomeration and suppression of caking.

The embodiments described above are merely examples of applying the principles of the present disclosure, and other embodiments may be further included without departing from the scope of the present disclosure.

What is claimed is:

1. A coated pellet comprising:
a core comprising a (meth)acrylic resin; and
an anti-blocking coating formed on a surface of the core and comprising an alkali metal salt,
wherein the content of the alkali metal salt is about 3 ppm to about 7,000 ppm based on the total weight of the core and the anti-blocking coating.

2. The coated pellet according to claim 1, wherein the content of the alkali metal salt is about 10 ppm to about 3,000 ppm based on the total weight of the core and the anti-blocking coating.

3. The coated pellet according to claim 1, wherein the (meth)acrylic resin comprises a (meth)acrylic acid-derived repeating unit.

4. The coated pellet according to claim 3, wherein the content of the (meth)acrylic acid-derived repeating unit is about 10% by weight to about 30% by weight based on the total weight of the (meth)acrylic resin.

5. The coated pellet according to claim 4, wherein the content of the (meth)acrylic acid-derived repeating unit is about 10% by weight to about 20% by weight based on the total weight of the (meth)acrylic resin.

6. The coated pellet according to claim 1, wherein the alkali metal salt comprises a sodium salt.

7. The coated pellet according to claim 1, wherein the alkali metal salt comprises an alkali metal phosphate.

8. The coated pellet according to claim 1, wherein the alkali metal salt does not comprise an alkali metal carboxylate.

9. The coated pellet according to claim 1, wherein the alkali metal salt comprises at least one selected from the group consisting of trisodium phosphate, sodium sulfite, sodium silicate, and sodium caprylate.

10. The coated pellet according to claim 1, wherein the (meth)acrylic resin comprises a repeating unit derived from a (meth)acrylic monomer, and the (meth)acrylic monomer comprises at least one selected from the group consisting of an alkyl (meth)acrylate, a hydroxyl-containing (meth)acrylate, a carboxyl-containing (meth)acrylate, and an alkoxy-containing (meth)acrylate.

11. The coated pellet according to claim 1, wherein the pH of the alkali metal salt is greater than the pH of the (meth)acrylic resin.

12. A method for manufacturing a coated pellet, the method comprising:
preparing a coating solution comprising an alkali metal salt and a solvent;
mixing a core comprising a (meth)acrylic resin with the coating solution to produce a preliminary coated pellet; and
drying the preliminary coated pellet to produce a coated pellet,
wherein the content of the alkali metal salt is about 0.03% by weight to about 5.0% by weight based on the total weight of the coating solution.

13. The method for manufacturing a coated pellet according to claim 12, wherein the content of the alkali metal salt is about 0.03% by weight to about 0.5% by weight based on the total weight of the coating solution.

14. The method for manufacturing a coated pellet according to claim 12, wherein the drying is performed for about 20 to about 30 hours.

15. The method for manufacturing a coated pellet according to claim 12, wherein the drying is performed at a temperature of about 20° C. to about 30° C.

16. The method for manufacturing a coated pellet according to claim 12, wherein the alkali metal salt comprises an alkali metal phosphate.

17. The method for manufacturing a coated pellet according to claim 12, wherein the alkali metal salt does not comprise an alkali metal carboxylate.

18. The method for manufacturing a coated pellet according to claim 12, wherein the alkali metal salt comprises at least one selected from the group consisting of trisodium phosphate, sodium sulfite, sodium silicate, and sodium caprylate.

19. The method for manufacturing a coated pellet according to claim 12,
wherein the (meth)acrylic resin comprises a repeating unit derived from a (meth)acrylic monomer, and the (meth)acrylic monomer comprises at least one selected from the group consisting of an alkyl (meth)acrylate, a hydroxyl-containing (meth)acrylate, a carboxyl-containing (meth)acrylate, and an alkoxy-containing (meth)acrylate, and
wherein the pH of the alkali metal salt is greater than the pH of the (meth)acrylic resin.

20. A coated pellet comprising:
a core comprising an acrylic resin; and
an anti-blocking coating formed on a surface of the core and comprising an alkali metal salt, wherein the acrylic resin includes a (meth)acrylic resin,
and wherein the alkali metal salt includes at least one selected from the group consisting of trisodium phosphate, sodium sulfite, sodium silicate, and sodium caprylate.
